(19) United States
(12) Patent Application Publication
(10) Pub. No.: US 2022/0104660 A1
(43) Pub. Date: Apr. 7, 2022

(54) AUTOMATED METHOD AND SYSTEM FOR PARTICLE DOSING FROM A PARTICLE STORAGE CONTAINER

(71) Applicant: Omri Almagor, Milano (IT)

(72) Inventor: Omri Almagor, Milano (IT)

(21) Appl. No.: 17/180,005

(22) Filed: Feb. 19, 2021

Related U.S. Application Data
(60) Provisional application No. 63/087,314, filed on Oct. 5, 2020.

(51) Int. Cl. A47J 42/50; A47J 42/44; A23F 5/08; G01G 13/20

(52) U.S. Cl. CPC A47J 42/50; G01G 13/20; A23F 5/08; A47J 42/44

(57) ABSTRACT

Embodiments of improved systems including and methods for dosing or distributing a desired amount or dose of particles from a storage container by determining the weight of the storage container as particles are distributed. Other embodiments may be described and claimed.

### TECHNICAL FIELD

Various embodiments described herein relate generally to automated methods and systems for distributing a desired amount or dose of particles from a storage container.

### BACKGROUND INFORMATION

It may be desirable to provide automated systems and methods for distributing a desired amount or dose of particles from a storage container; the present invention provides such systems and methods.

### BRIEF DESCRIPTION OF THE DRAWINGS

FIG. 1A is a simplified diagram of an automated system that improves the distribution of a desired amount or dose of particles from a storage container according to various embodiments.

FIG. 1B is a simplified diagram of an automated system that improves the distribution of a desired amount or dose of particles from a storage container to a particle processing mechanism according to various embodiments.

FIG. 1C is a simplified diagram of an automated system that improves the production of coffee via the distribution of a desired dose of coffee bean from a storage container to a coffee bean grinder for use by a brew unit according to various embodiments.

FIG. 2A is a diagram of an improved algorithm for distributing a desired amount or dose of particles from a storage container according to various embodiments.

FIG. 2B is a diagram of an improved algorithm for distributing a desired amount or dose of particles from a storage container to a particle processing mechanism according to various embodiments.

FIG. 2C is a diagram of an improved algorithm for production of coffee/espresso via the distribution of a desired dose of coffee beans from a storage container to a coffee bean grinder for use by a brew unit according to various embodiments.

FIG. 2D is a diagram of another improved algorithm for production of coffee/espresso via the distribution of a desired dose of coffee beans from a storage container to a coffee bean grinder for use by a brew unit according to various embodiments.

FIG. 3A is a simplified isometric drawing of an improved particle distribution system according to various embodiments.

FIG. 3B is a simplified cross-sectional drawing of the system shown in FIG. 3A according to various embodiments.

FIG. 3C is a simplified, isometric, offset, exploded view of the system shown in FIG. 3A according to various embodiments.

FIG. 4 is a block diagram of an article according to various embodiments.

### DETAILED DESCRIPTION

In an automatic system that includes a particle storage container coupled to a particle distribution mechanism that distributes particles from the storage container, it is desirable to distribute a known quantity or amount of the particles 5. In an embodiment, the desired distributed amount is based on the weight of the particles distributed from a storage container. In an embodiment, the desired particle 5 weight (termed dose) may vary as a function of the next use of the particles 5. In an embodiment, the storage container ideally may hold many doses of particles, about 5 to 200 doses in an embodiment.

In an embodiment, the particles may be coffee beans (roasted or green) and the storage container (termed a hopper in an embodiment) may hold the coffee beans. To create a brewed espresso weighting about 30 g (grams), 20 g of coffee beans may be ideally consumed-used (ratio of about 1.5 espresso to coffee beans). For regular coffee, however the ideal ratio may be about 1.18. Accordingly, in an automated system and method for distributing particles (such as coffee beans) from a storage container (such as coffee bean hopper), the desired dose (weight) of particles in a dose (coffee beans) may vary as a function of the next usage of the particles (to produce an espresso, cup of coffee, for example).

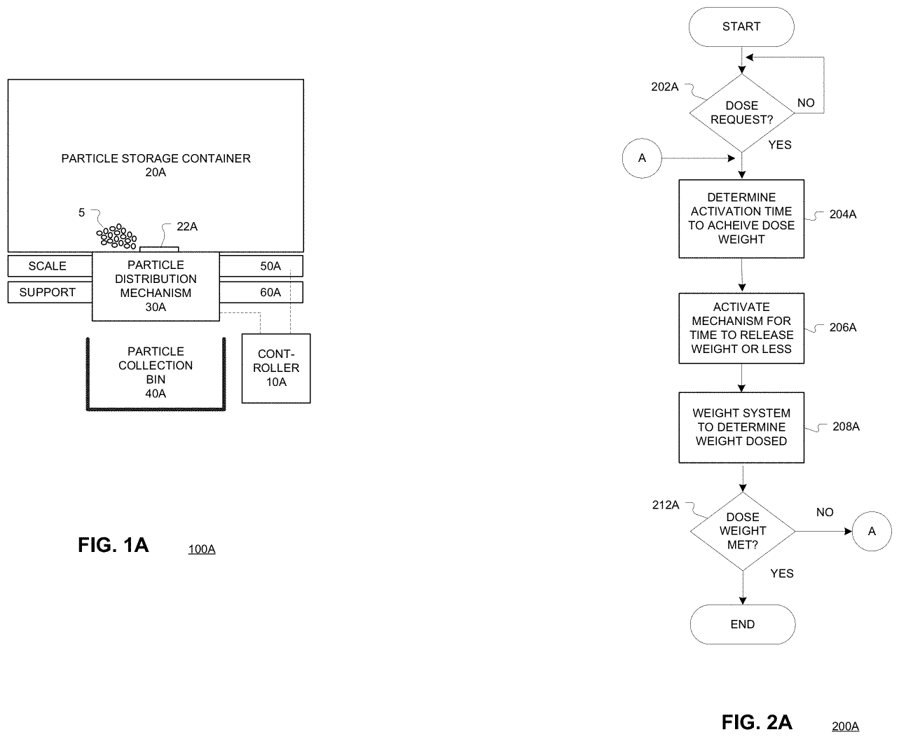

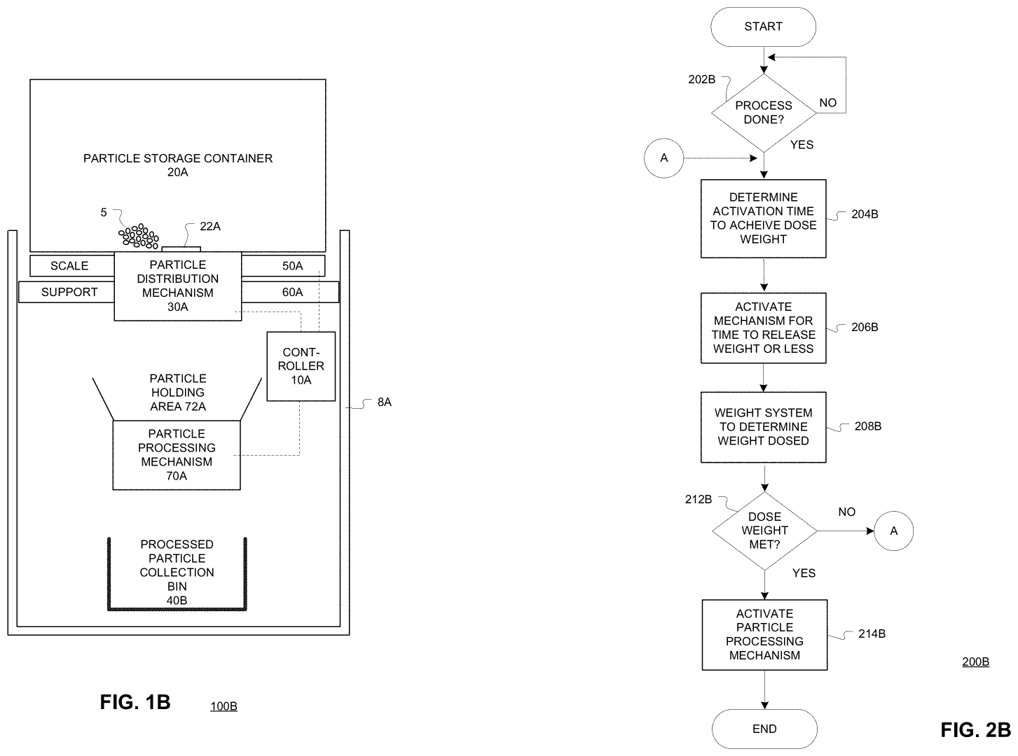

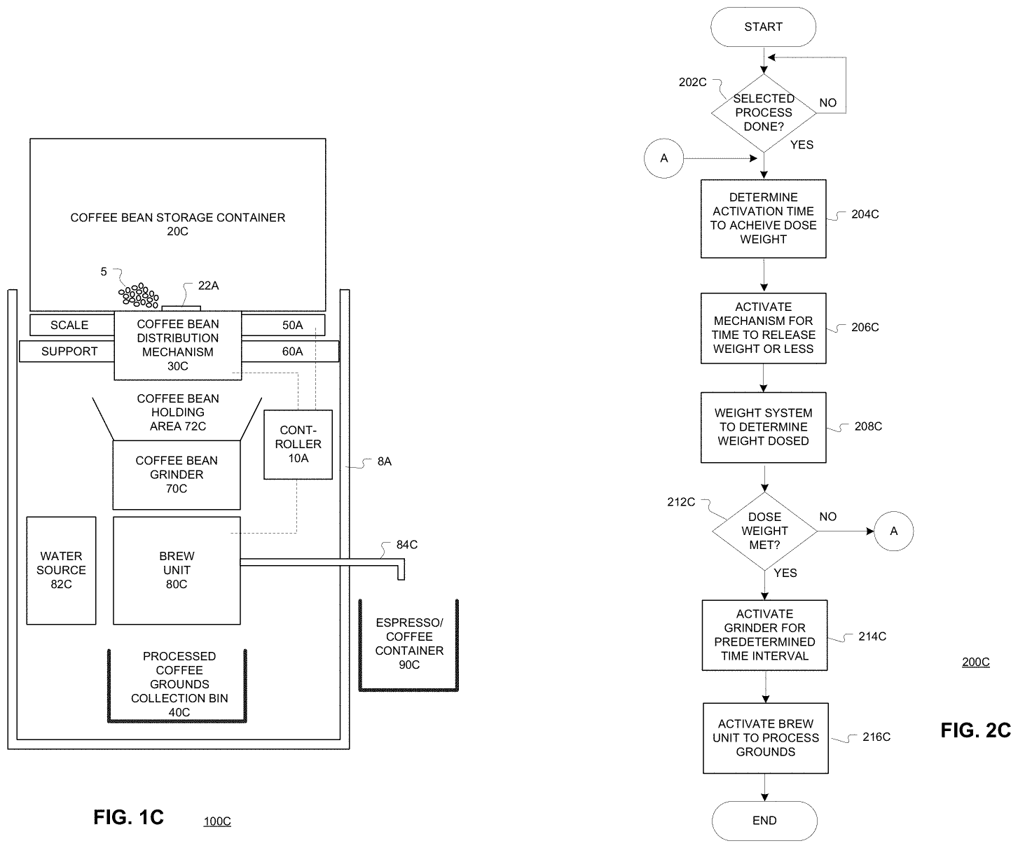

FIG. 1A is a simplified diagram of an automated system 100A that improves the distribution of a desired amount or dose of particles 5 from a storage 20A container according to various embodiments. As shown in FIG. 1A, system 100A may include a particle storage container 20A, particle distribution mechanism 30A, scale or weighting mechanism/module 50A, support 60A, particle collection bin 40A, and a controller 10A. In an embodiment, the particle storage container (PSC) 20A may communicate particles 5 via an opening 22A to the particle distribution mechanism (PDM) 30A. In an embodiment, the PSC 20A and PDM 30A are coupled to a support 60A only via a scale or weight module 50A so the weight module 50A can determine the weight of the combination of the PSC 20A, PDM 30A, and any particles 5 therein. The particle collection bin 40A is not directly coupled the PSC or PDM. As shown in FIGS. 1B and 1C, the support 60A may be coupled to a wall 8A or main section of the system 100B-C while the PSC 20A/PDM 30A combination is effectively floating via the scale 50A from the wall or main section 8A.

A controller 10A may be coupled to the scale or weight module 50A and receive either an analog or digital signal that indicates the weight of the combination of the PSC 20A, PDM 30A, and any particles 5 therein. The controller 10A may also know the weight of the combination of the PSC 20A, PDM 30A alone (no particles)—i.e., the tare weight. Based on the tare weight, the controller 10A may be able to determine the weight of any particles 5 in the combination of PSC 20A, PDM 30A based on the weight module signal 50A.

In an embodiment, the combination of the PSC 20A and PDM 30A may have a tare weight of about 100 to 2000 grams and be able to store from 100 to 1000 grams of particles 5. The weight module 50A may be able to affect or provide a signal indicating weights from 10 to 3000 grams with an accuracy of 0.1 to 0.8 grams in an embodiment. In an embodiment, the weight module 50A may include a load cell, strain gauge, or other devices capable of providing the required degree of accuracy as a function of the particle 5 weight and dose weight. The controller 10A may also be coupled to the PDM 30A to control and vary the distribution rate of particles 5 such as 1 to 50 particles for a predetermined time interval (such as per second . . . ) if so desired in an embodiment. For example, in an embodiment, the PDM 30A may include a motor 35D coupled to a distribution device such as blades, rotating window sized to permit particles to pass therethrough, auger 33D, or another device.

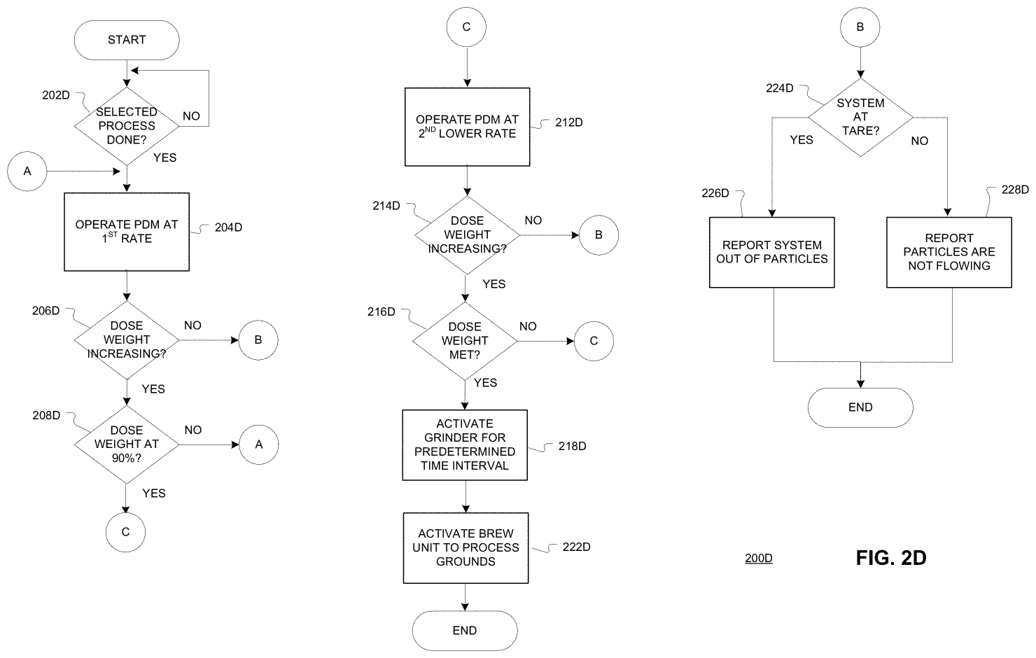

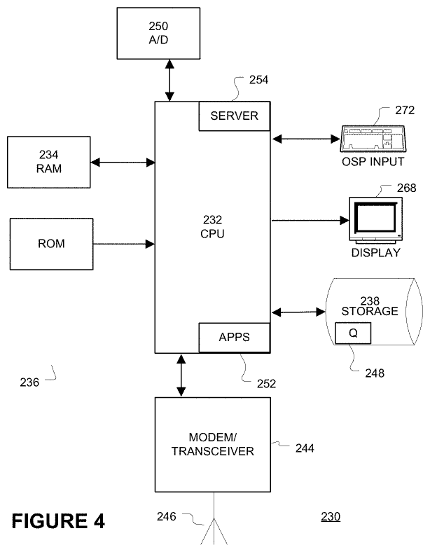

In operation, controller 10A may employ the algorithm 200A shown in FIG. 2A or the algorithm 200D shown in FIG. 2D to direct the operation of the PDM 30A to release a desired weight (dose) of particles 5 into a particle collection bin 40A when a dose of certain weight is requested (activity 202A). In an embodiment, a User via an input device 272 (FIG. 4) or a User device communicating with the controller 10A via an interface 244 (FIG. 4) may request an operation that distributes or requires the distribution of a certain weight of particles 5 from the PSC/PDM combination such as 20 grams of particles (coffee beans) to produce an espresso of 30 grams.

In an embodiment based on the requested dose, the controller 10A may activate the PDM for a first predetermined time interval 30A (activity 204A). The predetermined time interval may be based on preprogrammed ratios of time to dose. Such ratios may be based on calibration of the PSC/PDM for certain particles 5. The User may be able to specify the particles 5 in the PSC/PDM so the activation time may be adjusted accordingly. In an embodiment, the first predetermined time interval may be selected to provide slightly less than the desired weight or dose to prevent over distribution of particles 5 (activity 206A). For example, where 20 grams of particles are desired (dose weight of 20 grams), the PDM 30A may be activated to distribute a certain percentage less (from 5 to 20% less) and then weight the PSC/PDM-particles 5 remaining combination (activity 208A).

Based on the combined weight of the PSC/PDM-particles 5 prior to PDM 30A activation, the dose of particles 5 distributed may be determined. When the dose weight is within a tolerance (within the weight mechanism accuracy) or a percentage of the dose weight in an embodiment (0.5 to 5% in an embodiment), the distribution process may be complete. For example where the desired dose weight is 20 g, the desired accuracy may be 0.2 g or about one particle (coffee bean). Otherwise, the differential between the required weight or dose and that distributed thus far may be determined and used to determine a differential dose that is distributed using algorithm activities 204A-212A until the desired total dose is distributed within tolerance. Such a process may eliminate weighting errors versus continuously weighting the combination of PSC/PDM-remaining particles 5 while the PDM 30A actively distributing particles 5.

In another embodiment, the controller 10A may continuously weight-receive an indication of weight from the weight mechanism 50A of the combination of PSC/PDM-remaining particles 5 while the PDM 30A is actively distributing particles 5. The controller 10A may continue to direct the PDM 30A to operate until the desired dose weight (loss of weight of combination of PSC/PDM-particles 5 equals the desired particle 5 weight dose) is achieved within tolerances. In particular, in an embodiment, a controller 10A may employ the algorithm 200D shown in FIG. 2D to distribute a desired dose (weight) of particles 5.

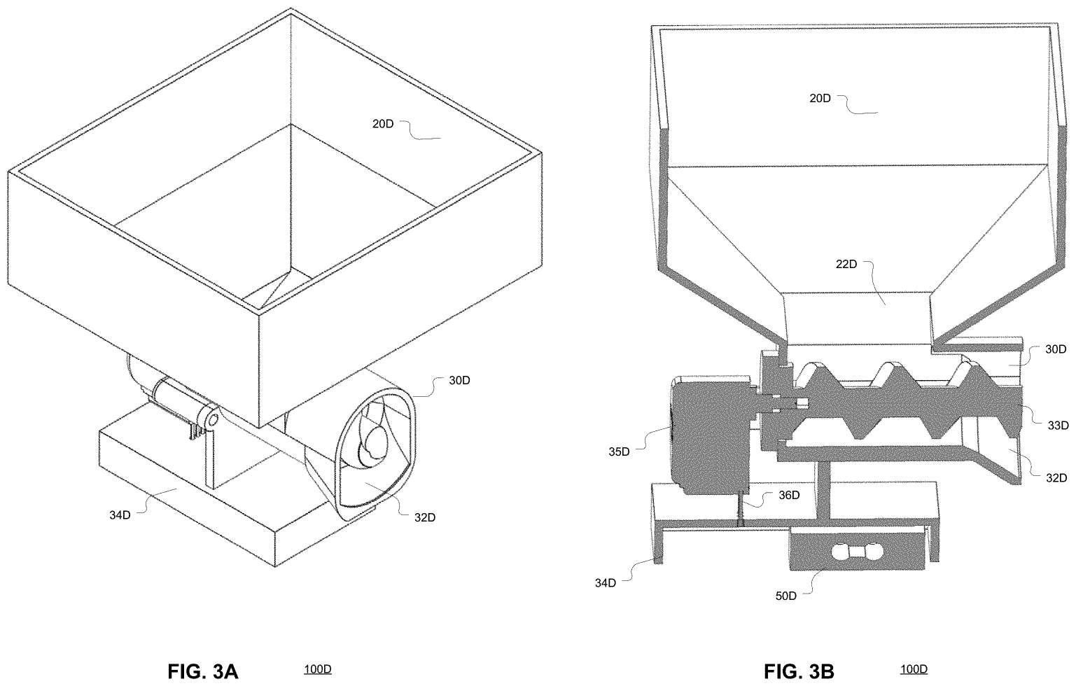

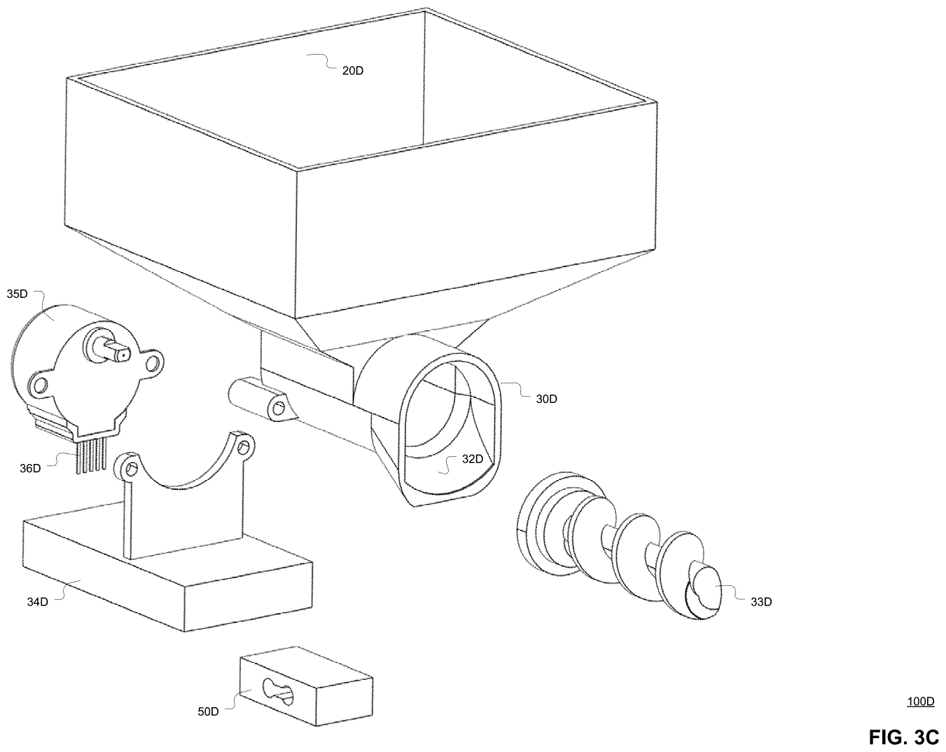

As shown in FIG. 2D when a dose is requested or some other process is done (activity 202D) enabling or requiring a dose to be distributed, the controller 10A may direct a PDM 30A to distribute particles 5 at a first distribution rate where the rate may vary as a function of the requested dose weight. For example, where the selected or desired dose weight is 20 g, the controller 10A may direct a PDM 30A to distribute about 1 to 5 g per second of particles 5. As shown in FIG. 3A-3C, a PDM 30D may include a motor 35D and auger 33D. The controller 10A may cause the motor 35D and thus the auger 33D to rotate a desired rate (rotations per minute—RPM) so particles are distributed at a desired rate (grams per second or particles per second) in an embodiment. As noted, that controller 10A via a scale 20D may be able to determine the amount (number or weight) of particles distributed or dosed by monitoring the overall weight of the PDM 30A, PSC 20A and any particles 5 located therein.

While the controller 10A is directing a PDM 30A to operate it may determine whether the dose weight (particles 5 distributed weight) continues to increase (activity 206D). The controller 10A via a scale 20D may be able to determine the overall weight to the PDM 30A, PSC 20A and any particles 5 located therein is not changing over time and thus particles 5 are not being distributed. The controller 10A via the known tare weight of the PDM 30A and PSC 20A and the current measured weight via the scale 50A (activity 224D) may be able to determine and report that a system 100A-D is out of particles 5 (activity 226D). Otherwise, when flow of particles 5 has stopped but the tare weight has not been detected, the controller 10A may report that the remaining particles 228D are not flowing in the system 100D. In an embodiment, the controller 10A may engage a vibration module coupled to the PSC 20A or PDM 30A to attempt to enable particles to flow when they are determined not to be flowing. In such an embodiment, the weight of the vibration module may be known and included in the overall weight of the PDM 30A, PSC 20A and any particles 5 located therein. For example, the particles 5 may be coffee beans and may stick together or a wall in a PSC 20A.

When the dose weight continues to increase (at a desired rate in an embodiment), the controller 10A may direct the PDM 30A to continue to distribute particles 5 at the first rate until the desired does weight (of distributed particles 5) is achieved. In an embodiment, once the controller 10A determines a predetermined percentage (lower than 100%) of dose weight is achieved (activity 208D) such as about 80% to 95% or about 90% in an embodiment, the controller 10A may reduce the distribution rate of a PDM 30A to a second, lower rate (activity 212D). For example, the controller 10A may lower the distribution rate to 1 particle (coffee bean) per second for the second rate in an embodiment. The controller 10A may continue to ensure that particles are being distributed by monitoring overall weight (activity 214D) and continue to operate the PDM 30A at the second, lower rate until the desired dose (weight) is achieved (activity 216D) within tolerances (e.g., within 0.2 g for a 20 g dose). Depending on the system 100A-D other activities may be performed once the dose weight is achieved including activating a particle processing mechanism 70A such a grinder 70C and another system to use the processed particles, such as a brew unit 80C.

FIG. 1B is a simplified diagram of another automated system 100B that improves the distribution of a desired amount or dose of particles 5 from a storage container 22A to a particle processing mechanism 70A via a PDM 30A according to various embodiments. As shown in FIG. 1B, the system 100B further includes a particle processing mechanism (PPM) 70A with a particle holding area 72A. In an embodiment, the controller 10A communicates with the PDM 30A, weight module 50A, and the PPM 70A. Controller 10A may employ the algorithms 200B, 200D shown in FIGS. 2B and 2D to process particle dosing requests in system 100B. In an embodiment, system 100B may distribute a dose of particles 5 when a User selects a function that requires or needs a dose of particles 5 or after another process has been completed (activity 202B). For example, to limit scaling errors or speed up processing times, a controller 10A may direct the PDM 30A to distribute particles 5 to the particle holding area 72A once the PPM 70A has completed processing a previous dose of particles 5 in its holding area, i.e., once the holding area 72A is empty.

In an embodiment, the PPM 70A may be directed to process particles in its holding area 72A when the required dose of particles 5 has been distributed therein by the PSC/PDM per activities 204B-212B (activity 214B). The results of the PPM 70A processing may be collected in the processed particle collection bin 40B. For example, in an embodiment the particles 5 may be coffee beans and the PPM 70A may be a grinder. FIG. 1C is a simplified diagram of an automated system 100C that improves the production of espresso-coffee via the distribution of a desired dose of coffee beans 5 from a storage container 20C to a coffee bean grinder 70C for use by a brew unit 80C according to various embodiments.

As shown in FIG. 1C, the system 100C includes a PSC 20C, PDM 30C, scale—weight mechanism 50A, support 60A, controller 10A, coffee bean holding area 72C, coffee bean grinder 70C, brew unit 80C, water source 82, processed coffee grounds collection bin 40C, brew unit spout 84C, and espresso-coffee container 90C. In the embodiments 100A-100C, the PSC 20A may have an opening 22A that enables particles 5 to pass to the PDM 30A for distribution when activated by a controller 10A. In an embodiment, the controller 10A may employ the algorithm 200C shown in FIG. 2C to generate coffee or expresso for collection by the coffee container 90C at the direction of a User via a system input device 272 or User device communicating the controller 10A via a modem-transceiver 244 (FIG. 4).

In an embodiment, the controller 10A may direct the PDM 30C to distribute a dose of coffee beans 5 to the coffee holding area 72C (activities 204C-212C) when either the grinder 70C or the brew unit 80C have completed their cycles (activities 214C, 216C) in an embodiment. Once a dose of coffee beans 72C has been distributed into the coffee bean holding area 72C, the controller 10A may activate the grinder 70C for a predetermined time sufficient to process all beans in the holding area 70C (activity 214C). In an embodiment, the output of the grinder (coffee grounds) may be directed in the brew unit 80C for processing. Once the grinder 70C has been activated for the predetermined time interval, the controller 10A may direct the brew unit 80C to process the received grounds (activity 216C). The brew unit 80C may generate coffee-espresso via the spout 84C into container 90C and send spent grounds into the ground collection bin 40C (activity 216C).

FIG. 3A is a simplified isometric drawing of an improved particle distribution system 100D according to various embodiments. FIG. 3B is a simplified cross-sectional drawing of the system 100D shown in FIG. 3A according to various embodiments. FIG. 3C is a simplified, isometric, offset, exploded view of the system 100D shown in FIG. 3A according to various embodiments. As shown in FIGS. 3A-3C, the system 100D includes the PSC 20D with an extended opening 22D that could be part of the PDM 30A-C in an embodiment. The PDM 30D includes a particle chute 32D, auger 33D, base 34D, motor 35D, and motor wiring 36D. The weight module 50D may include a load cell.

As shown in FIGS. 3A-3C, the motor 35D is coupled to the auger 33D and when activated causes the auger 33D to rotate, causing particles 5 to fall into the auger blades 37D and advance to the chute 32D. As the particle 5 fall out of the auger 33D and chute 32D, they will not contribute to the weight of the PSC 20D, PDM 30D, and any remaining particles 5. Accordingly as described above, a controller 10A coupled to the load cell 50D will be able to determine the dose (weight) of particles 5 distributed out of the system 100D and the weight of the particles 5 remaining (based on tare weight of the system 100D).

FIG. 4 illustrates a block diagram of a device 230 that may be employed as a controller 10A in various embodiments to perform the algorithms 200A-C and communicate with a User device. The device 230 may include a CPU 232, a RAM 234, a ROM 236, a storage unit 238, a modem/transceiver 244, a digital to analog converter 250, an input module 272, display module 268, and an antenna 246. The CPU 232 may include a web-server 254 and application module 252. The RAM 234 may include a queue or database where the database may be used to store information including particle data, requests for distributions, and user information such as desired doses for various particle usage. The storage 238 may also include a queue or database 248 where the database 248 may be used to store particle distribution requests and related processing requests in an embodiment. In an embodiment, the server 254 and the application module 252 may be separate elements. In an embodiment, the server 254 may generate content for web-pages or displays to be forwarded to a user to control the operation of a system 100A-D.

The user input device 272 may comprise an input device such as a keypad, touch screen, track ball or other similar input device that allows the user to navigate through menus, displays in order to operate systems 100A-D. The display 268 may be an output device such as a CRT, LCD, touch screen, or other similar screen display that enables the user to read, view, or hear received messages, displays, or pages from the system 100A-D.

The modem/transceiver 244 may couple, in a well-known manner, the device 230 to a user device to enable communication with the CPU 232. In an embodiment, the modem/transceiver 244 may be a wireless modem or other communication device that may enable communication with a user device. The CPU 232 via the server 254 or application 252 resident on a user device may direct communication between modem 244 and a user device.

The ROM 236 may store program instructions to be executed by the CPU 232, server 254, or application module 252. The RAM 234 may be used to store temporary program information, queues, databases, and overhead information. The storage device 238 may comprise any convenient form of data storage and may be used to store temporary program information, queues, databases, and overhead information.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. An automatic system for distributing desired doses of particles, the system comprising:
a particle storage container (PSC) sized to store a plurality of desired doses of particles and including an opening to pass particles;
a particle distribution mechanism (PDM) physically coupled to the PSC to receive particles from the PSC opening and controllably distribute particles to a location separate from the PDM and PSC;
an electronic scale coupled to one of the PSC and the PDM to measure their combined weight and particles in the PSC and PDM; and
a controller electrically coupled to the PDM and the electronic scale and when a dose of particles is requested directing the PDM to distribute particles until the dose of particles has been distributed to a location separate from the PDM and PSC based on the measured weight of the PSC, PDM, and particles in the PSC and PDM.

2. The automated system for distributing desired doses of particles of claim 1, wherein the requested dose size can vary.

3. The automated system for distributing desired doses of particles of claim 1, wherein the PDM controllably distribute particles to a particle collection bin physically separate from the PDM and PSC.

4. The automated system for distributing desired doses of particles of claim 1, wherein the controller determines the weight of particles in the PSC and PDM based on the measured weight and known weight of the PSC and PDM.

5. The automated system for distributing desired doses of particles of claim 1, wherein the PDM controllably distribute particles to a particle holding area of a particle processing mechanism physically separate from the PDM and PSC.

6. The automated system for distributing desired doses of particles of claim 1, wherein the particles are coffee beans.

7. The automated system for distributing desired doses of particles of claim 5, wherein the particles are coffee beans and the particle processing mechanism is a coffee grinder.

8. The automated system for distributing desired doses of particles of claim 7, wherein a controller is electrically coupled to the particle processing mechanism and directing the particle processing mechanism to process the distributed particles when the requested dose of particles has been distributed to particle holding area of a particle processing mechanism.

9. The automated system for distributing desired doses of particles of claim 2, wherein the PDM includes an auger sized to move particles axially when rotated.

10. The automated system for distributing desired doses of particles of claim 9, wherein the auger is coupled to a motor and the motor is coupled to the controller.

11. An automatic method for distributing desired doses of particles from a particle distribution mechanism (PDM) physically coupled to a particle storage container (PSC), the PSC sized to store a plurality of desired doses of particles and including an opening to pass particles to PDM, the method including:
employing an electronic scale coupled to one of the PSC and the PDM to measure the combined weight of the PSC and the PDM and particles in the PSC and PDM; and
directing the PDM to distribute particles to a location separate from the PDM and PSC until the measured weight of the PSC, PDM, and particles in the PSC and PDM is reduced by the weight of the requested dose of particles.

12. The automated method for distributing desired doses of particles of claim 11, wherein the requested dose size can vary.

13. The automated method for distributing desired doses of particles of claim 11, directing the PDM to distribute particles to a particle collection bin physically separate from the PDM and PSC until the measured weight of the PSC, PDM, and particles in the PSC and PDM is reduced by the weight of the requested dose of particles.

14. The automated method for distributing desired doses of particles of claim 11, further including determining the weight of particles in the PSC and PDM based on the measured weight of the PSC, PDM, and particles in the PSC and PDM and known weight of the PSC and the PDM.

15. The automated method for distributing desired doses of particles of claim 11, directing the PDM to distribute particles to a particle holding area of a particle processing mechanism physically separate from the PDM and PSC until the measured weight of the PSC, PDM, and particles in the PSC and PDM is reduced by the weight of the requested dose of particles.

16. The automated method for distributing desired doses of particles of claim 11, wherein the particles are coffee beans and reporting that PSC is one out of coffee beans and the coffee beans are not flowing when the measured combined weight of the PSC and the PDM and particles in the PSC and PDM remains constant for a predetermined time interval while directing the PDM to distribute particles.

17. The automated method for distributing desired doses of particles of claim 15, wherein the particles are coffee beans and the particle processing mechanism is a coffee grinder.

18. The automated method for distributing desired doses of particles of claim 17, further including directing the particle processing mechanism to process the distributed particles when the requested dose of particles has been distributed to particle holding area of a particle processing mechanism.

19. The automated method for distributing desired doses of particles of claim 2, wherein the PDM includes an auger sized to move particles axially when rotated.

20. The automated method for distributing desired doses of particles of claim 19, wherein the auger is coupled to a motor and directing the motor to rotate the auger to distribute particles to a particle collection bin physically separate from the PDM and PSC until the measured weight of the PSC, PDM, and particles in the PSC and PDM is reduced by the weight of the requested dose of particles.
